(19) United States
(12) Patent Application Publication
(10) Pub. No.: US 2025/0289355 A1
(43) Pub. Date: Sep. 18, 2025

(54) Work Vehicle

(71) Applicant: Kubota Corporation, Osaka-shi (JP)

(72) Inventors: Shinya Tabata, Osaka (JP); Seigi Aratake, Osaka (JP); Akira Tominaga, Osaka (JP); Tetsushi Hamatake, Osaka (JP); Shunsuke Higashigawa, Osaka (JP)

(21) Appl. No.: 18/978,390

(22) Filed: Dec. 12, 2024

(30) Foreign Application Priority Data
Mar. 15, 2024 (JP) 2024-041171

(51) Int. Cl. B60N 3/06; B62D 25/20

(52) U.S. Cl. CPC B60N 3/06; B62D 25/20

(57) ABSTRACT

A work vehicle includes an operation pedal which is forward and downward of a driver seat and which is configured to control a traveling speed of the work vehicle in response to the operation pedal being stepped on by a driver sitting on the driver seat, a footrest section which is forward and downward of a passenger seat and which is used for a passenger sitting on the passenger seat to put a foot on, and a partition section which is between the operation pedal and the footrest section and which separates a region for the operation pedal from the footrest section. The partition section has a rear portion including a rear inclined surface portion configured such that a further forward portion of the rear inclined surface portion is closer to the footrest section in a plan view.

### CROSS-REFERENCE TO RELATED APPLICATION

This application claims priority to Japanese Patent Application No. 2024-041171 filed Mar. 15, 2024, the disclosure of which is hereby incorporated by reference in its entirety.

### BACKGROUND OF THE INVENTION

### Field of the Invention

The present invention relates to a configuration around a driver seat and a passenger seat in a work vehicle.

### Description of the Related Art

As disclosed in Japanese Unexamined Patent Application Publication No. 2023-7623, some multipurpose vehicles as an example of a work vehicle include a driver seat and a passenger seat arranged in the right-left direction. A work vehicle may include a large seat in which a driver seat and a passenger seat are continuous in the right-left direction or may include a passenger seat increasing in width in the right-left direction than the width of a driver seat in the right-left direction so that two passengers can sit on the passenger seat.

When two passengers sit on the passenger seat in such a work vehicle, a passenger sitting on a passenger seat adjacent to the driver seat is close to the driver seat. In this case, it is concerned that the passenger sitting on the passenger seat might wrongly step on an operation pedal (for example, an accelerator pedal) for controlling a traveling speed which operation pedal is provided forward and downward of the driver seat.

### SUMMARY OF THE INVENTION

In view of the foregoing, in order to prevent the passenger sitting on the passenger seat from wrongly stepping on the operation pedal, it is suggested that a partition section for separating a region for the operation pedal from a region forward and downward of the passenger seat be provided. An object of the present invention is to appropriately prevent a passenger sitting on a passenger seat from wrongly stepping on an operation pedal, in a case where a partition section for separating a region for the operation pedal from a region forward and downward of the passenger seat is provided.

A work vehicle of the present invention includes: a driver seat; a passenger seat adjacent to the driver seat; an operation pedal which is forward and downward of the driver seat and which is configured to control a traveling speed of the work vehicle in response to the operation pedal being stepped on by a driver sitting on the driver seat; a footrest section which is forward and downward of the passenger seat and which is used for a passenger sitting on the passenger seat to put a foot on; and a partition section which is between the operation pedal and the footrest section and which separates a region for the operation pedal from the footrest section. The partition section has a rear portion including a rear inclined surface portion configured such that a further forward portion of the rear inclined surface portion is closer to the footrest section in a plan view.

In the present invention, in a case where a passenger sitting on the passenger seat puts his or her feet on the footrest section (a lateral side of the partition section which lateral side faces the passenger seat), even when the passenger is to move his or her foot toward the operation pedal, the foot of the passenger is stopped by the partition section.

Assume a case where the passenger sitting on the passenger seat puts his or her foot near the rearward of the partition section, for example. When the passenger is to move the foot forward in this state, the foot of the passenger easily comes into contact with the rear inclined surface portion of the partition section, so that the foot of the passenger is easily guided to the footrest section along the rear inclined surface portion of the partition section.

Hereby, even when the passenger sitting on the passenger seat is to move the foot forward from a state where the passenger puts the foot near the rearward of the partition section, the foot of the passenger rarely moves from the partition section toward the operation pedal.

In the present invention, in either of the case where the passenger sitting on the passenger seat puts his or her feet on the footrest section (the lateral side of the partition section which lateral side faces the passenger seat) and the case where the passenger puts his or her foot near the rearward of the partition section, it is possible to reduce such a possibility that the foot of the passenger moves toward the operation pedal, thereby making it possible to appropriately prevent the passenger sitting on the passenger seat from wrongly stepping on the operation pedal.

In the present invention, the rear inclined surface portion may be in a shape increasing in width in a right-left direction toward a lower side in a back view.

In the present invention, the width, in the right-left direction, of the rear inclined surface portion of the partition section increases toward the lower side. Accordingly, in a case where the passenger sitting on the passenger seat is to move his or her foot forward from a state where the passenger puts the foot near the rearward of the partition section, the foot of the passenger easily comes into contact with the rear inclined surface portion of the partition section.

This is advantageous in that the possibility that the foot of the passenger moves toward the operation pedal is reduced and in that the passenger sitting on the passenger seat is prevented appropriately from wrongly stepping on the operation pedal.

In the present invention, the partition section may include a lateral surface portion facing the operation pedal which lateral surface portion includes a lateral inclined surface portion configured such that a further downward portion of the lateral inclined surface portion is closer to the operation pedal in the back view, and the rear inclined surface portion may be connected to the lateral inclined surface portion in such a manner as to be in a shape increasing in width in the right-left direction toward the lower side to be closer to the operation pedal in the back view.

In the present invention, the partition section includes the lateral surface portion facing the operation pedal which lateral surface portion includes the lateral inclined surface portion configured such that a further downward portion of the lateral inclined surface portion is closer to the operation pedal in the back view, and the rear inclined surface portion of the partition section is connected to the lateral inclined surface portion, so that the rear inclined surface portion of the partition section increases in width in the right-left direction toward the lower side to be directed toward the operation pedal.

This prevents the footrest section forward and downward of the passenger seat from being narrow, so that the space for the feet of the passenger sitting on the passenger seat is not narrow.

In the present invention, the partition section may include an upper end portion at a position higher than the operation pedal.

In the present invention, the partition section is high in height. This is advantageous in that the foot of the passenger sitting on the passenger seat is stopped by the partition section when the passenger is to move the foot on the footrest section (the lateral side of the partition section which lateral side faces the passenger seat) toward the operation pedal and is also advantageous in that the passenger sitting on the passenger seat is appropriately prevented from wrongly stepping on the operation pedal.

### BRIEF DESCRIPTION OF THE DRAWINGS

FIG. 1 is a left side view of a work vehicle;

FIG. 2 is a plan view around a driver seat, a passenger seat, and an operation panel;

FIG. 3 is a front view around the operation panel and a bottom panel;

FIG. 4 is a left side view of the bottom panel;

FIG. 5 is a plan view of the bottom panel;

FIG. 6 is a rear view of the bottom panel; and

FIG. 7 is a right side view of the bottom panel.

### DESCRIPTION OF THE INVENTION

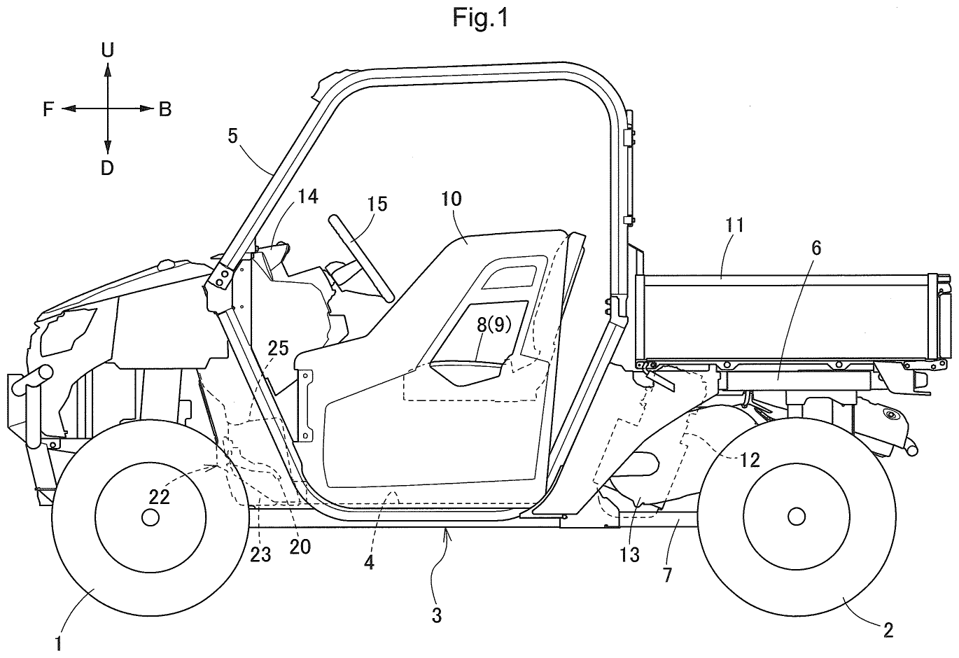

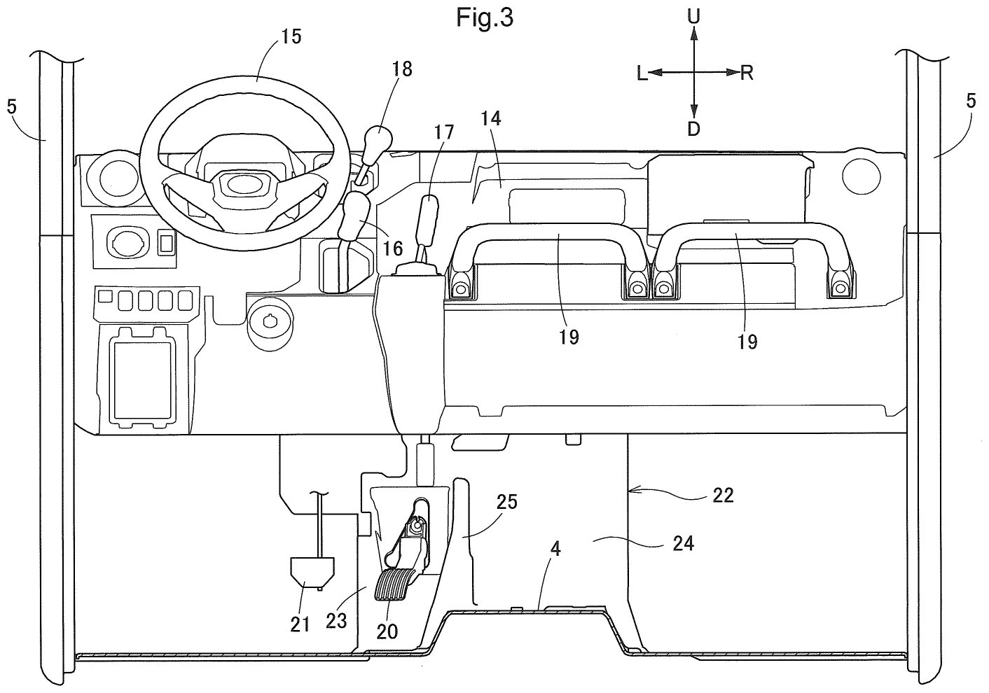

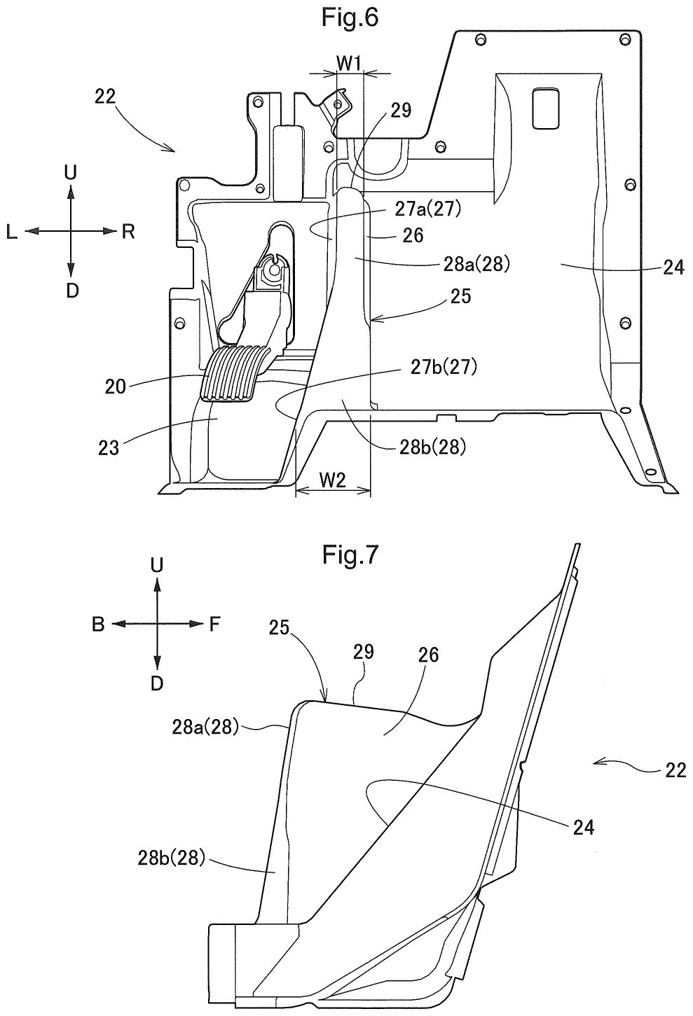

A multipurpose work vehicle as an example of a work vehicle is illustrated in FIGS. 1 to 7. In FIGS. 1 to 7, F designates a front direction, B designates a rear direction, U designates an upper direction, D designates a lower direction, R designates a right direction, and L designates a left direction.

### (Overall Configuration of Work Vehicle)

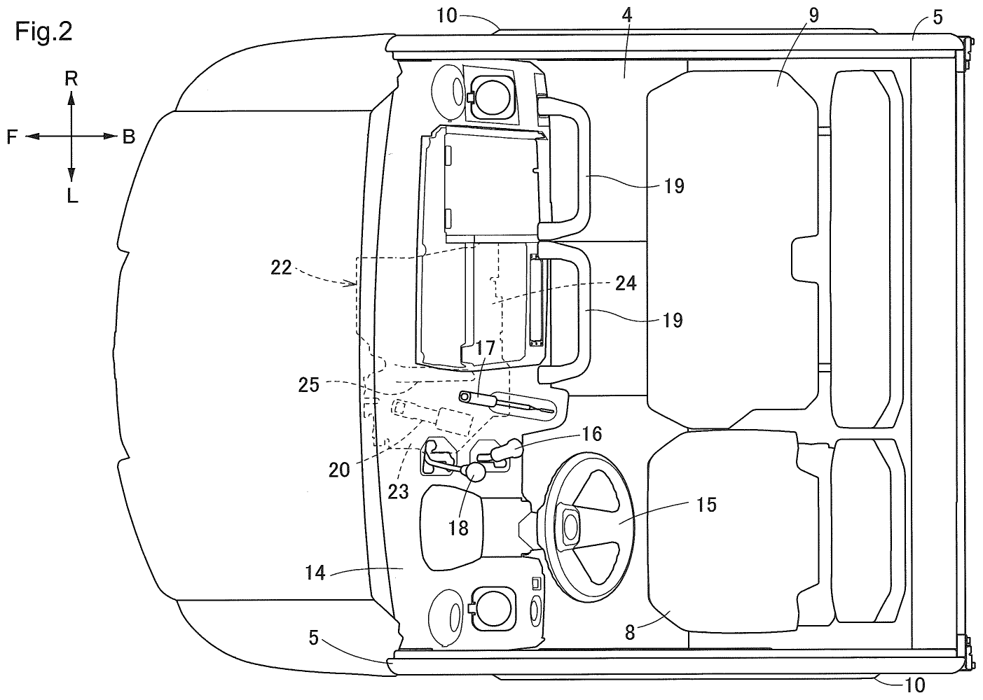

As illustrated in FIGS. 1, 2, the work vehicle includes right and left front wheels 1 at a front portion of a body 3, and right and left rear wheels 2 at a rear portion of the body 3 in such a manner that the body 3 is supported by the front wheels 1 and the rear wheels 2. The body 3 includes a floor frame 4, a ROPS frame 5, a rear frame 6, a bottom frame 7, and so on.

The floor frame 4 is provided with a driver seat 8 and a passenger seat 9, and the ROPS frame 5 is coupled to the floor frame 4 in such a manner as to cover the driver seat 8 and the passenger seat 9. Right and left doors 10 are attached to a right portion and a left portion of the ROPS frame 5 in such a manner as to be openable and closable. The passenger seat 9 has a width in the right-left direction which width is about twice the width of the driver seat 8, and two passengers can sit on the passenger seat 9.

The rear frame 6 and the bottom frame 7 are coupled to a rear portion of the ROPS frame 5 in such a manner as to extend rearward, and the rear frame 6 is provided with a cargo box 11.

### (Configuration of Travel Transmission System)

As illustrated in FIG. 1, the bottom frame 7 is provided with an engine 12, a continuously variable transmission 13, a transmission case (not illustrated), and the rear wheels 2. The transmission case contains a gear-shift-type sub-transmission (not illustrated) that can shift between three forward stages and one reverse stage, a rear-wheel differential device (not illustrated), and a front-wheel transmission gear (not illustrated).

Power from the engine 12 is transmitted to the continuously variable transmission 13 and shifted. The power is then transmitted from the continuously variable transmission 13 to the sub-transmission so as to be shifted, then transmitted from the sub-transmission to the rear-wheel differential device, and finally transmitted from the rear-wheel differential device to the rear wheels 2. Power branching off between the sub-transmission and the rear-wheel differential device is transmitted to the front wheels 1 via the front-wheel transmission gear.

In response to the front-wheel transmission gear being operated to a four-wheel drive state, the power branching off between the sub-transmission and the rear-wheel differential device is transmitted to the front wheels 1, so that the four-wheel drive state in which the front wheels 1 and the rear wheels 2 are driven is established. In response to the front-wheel transmission gear being operated to a two-wheel drive state, the power is cut off at the front-wheel transmission gear, so that the two-wheel drive state in which the rear wheels 2 are driven is established.

### (Configuration Around Operation Panel 14)

As illustrated in FIGS. 1, 2, 3, the operation panel 14 is provided forward of the driver seat 8 and the passenger seat 9. A left portion (forward of the driver seat 8) of the operation panel 14 is provided with a steering wheel 15, a shift lever 16, a parking brake lever 17, and a switching lever 18.

An accelerator pedal 20 (corresponding to an operation pedal) and a brake pedal 21 are downward of the left portion (forward of the driver seat 8) of the operation panel 14. The operation panel 14 has a central portion and a right portion (forward of the passenger seat 9) provided with two auxiliary handles 19.

The continuously variable transmission 13 is a belt continuously variable type. When the rotation speed of the engine 12 increases in response to the accelerator pedal 20 being stepped on, the continuously variable transmission 13 is automatically operated to a high-speed side. When the rotation speed of the engine 12 decreases in response to the accelerator pedal 20 being eased off, the continuously variable transmission 13 is automatically operated to a low-speed side.

The steering wheel 15 performs a steering operation on the front wheels 1. The shift lever 16 operates the sub-transmission in the transmission case to any of the three forward stages and one reverse stage. The switching lever 18 switches the front-wheel transmission gear between the four-wheel-drive state and the two-wheel-drive state.

A brake (not illustrated) that can brake the front wheels 1 and the rear wheels 2 is provided, and the brake is operated to a braking state in response to the brake pedal 21 being stepped on. When the parking brake lever 17 is operated after the brake pedal 21 operates the brake to the braking state, the brake is kept in the braking state.

### (Configuration of Bottom Panel 22)

As illustrated in FIGS. 1, 2, 3, the bottom panel 22 is downward of the central portion of the operation panel 14 in the right-left direction to be disposed forward and downward of the driver seat 8 and forward and downward of a left portion (a portion adjacent to the driver seat 8) of the passenger seat 9 in such a manner as to be attached to the floor frame 4. The bottom panel 22 includes a pedal arrangement section 23, a footrest section 24, and a partition section 25 and is integrally made of synthetic resin.

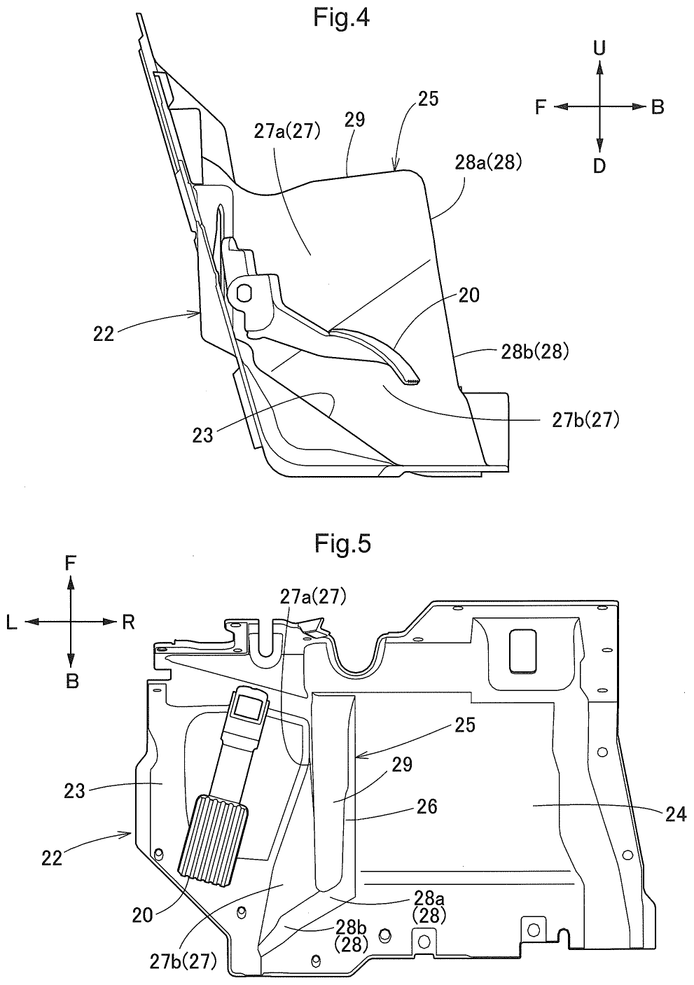

As illustrated in FIGS. 4, 5, 6, 7, in the bottom panel 22, the pedal arrangement section 23 is provided for a left portion (facing the driver seat 8) of the bottom panel 22 and has a front-rise inclined surface that becomes higher toward the front side. The pedal arrangement section 23 is provided with the accelerator pedal 20.

The footrest section 24 is provided for a right portion (facing the passenger seat 9) of the bottom panel 22 and has a front-rise inclined surface that becomes higher toward the front side. Mainly a passenger sitting on the left portion (the portion adjacent to the driver seat 8) of the passenger seat 9 can put his or her feet on the footrest section 24.

The partition section 25 has a square shape in a side view and is provided for a portion of the bottom panel 22 which portion is between the pedal arrangement section 23 and the footrest section 24. The partition section 25 separates the pedal arrangement section 23 (a region for the accelerator pedal 20) from the footrest section 24.

### (Configuration of Partition Section 25)—1

As illustrated in FIGS. 4, 5, 6, 7, the partition section 25 includes a right lateral surface portion 26, a left lateral surface portion 27 (corresponding to a lateral surface portion of the partition section 25 which lateral surface portion faces the operation pedal (the accelerator pedal 20)), and a rear inclined surface portion 28.

The right lateral surface portion 26 of the partition section 25 has a generally vertical surface along the front-rear direction and the up-down direction and is connected to the footrest section 24.

The left lateral surface portion 27 of the partition section 25 includes an upper-half portion 27a having a generally vertical surface along the front-rear direction and the up-down direction.

An upper end portion of the right lateral surface portion 26 of the partition section 25 is connected to an upper end portion of the upper-half portion 27a of the left lateral surface portion 27 to form an upper end portion 29 of the partition section 25. The upper end portion 29 is almost horizontal in a side view and is at a position higher than the accelerator pedal 20.

The left lateral surface portion 27 of the partition section 25 includes a lateral inclined surface portion 27b extending diagonally to the lower left side from a lower end portion of the upper-half portion 27a in such a manner as to be connected to the pedal arrangement section 23. The lateral inclined surface portion 27b is configured such that a further downward portion of the lateral inclined surface portion 27b is closer to the accelerator pedal 20 in a back view and extends rearward to be disposed rearward as it goes downward in a side view (a plan view).

### (Configuration of Partition Section 25)—2

As illustrated in FIGS. 4, 5, 6, 7, the partition section 25 includes the rear inclined surface portion 28 connected to a rear end portion of the right lateral surface portion 26 and a rear end portion of the left lateral surface portion 27 (the upper-half portion 27a and the lateral inclined surface portion 27b).

The rear inclined surface portion 28 of the partition section 25 includes an upper-half portion 28a connected to the rear end portion of the right lateral surface portion 26 and a rear end portion of the upper-half portion 27a of the left lateral surface portion 27, so that the rear inclined surface portion 28 has a small width W1 in the right-left direction in a back view.

The rear inclined surface portion 28 of the partition section 25 includes a lower-half portion 28b connected to the rear end portion of the right lateral surface portion 26 and a rear end portion of the lateral inclined surface portion 27b of the left lateral surface portion 27.

Since the lateral inclined surface portion 27b of the left lateral surface portion 27 extends rearward as it goes downward in a side view (a plan view), a left portion (a portion facing the pedal arrangement section 23 side) of the lower-half portion 28b of the rear inclined surface portion 28 projects rearward, so that the lower-half portion 28b of the rear inclined surface portion 28 includes an inclined surface configured such that a further forward portion of the rear inclined surface portion 28 is closer to the footrest section 24 in a plan view.

Since the lateral inclined surface portion 27b of the left lateral surface portion 27 is configured such that a further downward portion of the lateral inclined surface portion 27b is closer to the accelerator pedal 20 in a back view, a lower end portion of the lower-half portion 28b of the rear inclined surface portion 28 has a width W2 in the right-left direction which width W2 is larger than the width W1, in the right-left direction, of an upper end portion (the upper-half portion 28a) of the lower-half portion 28b of the rear inclined surface portion 28 in a back view. Hereby, the whole rear inclined surface portion 28 (the upper-half portion 28a and the lower-half portion 28b) is in a shape increasing in width in the right-left direction toward the lower side in a back view. More specifically, the whole rear inclined surface portion 28 is in a shape increasing in width in the right-left direction toward the lower side to be closer to the accelerator pedal 20 in a back view.

With the above configuration, in a case where the passenger sitting on the left portion (the portion adjacent to the driver seat 8) of the passenger seat 9 is to move his or her foot put on the footrest section 24 toward the accelerator pedal 20, the foot of the passenger is stopped by the right lateral surface portion 26 of the partition section 25.

Assume a case where the passenger sitting on the left portion (the portion adjacent to the driver seat 8) of the passenger seat 9 puts his or her foot near the rearward of the partition section 25, for example. When the passenger is to move the foot forward in this state, the foot of the passenger comes into contact with the rear inclined surface portion 28 of the partition section 25, so that the foot of the passenger is guided to the footrest section 24 along the rear inclined surface portion 28 of the partition section 25. (First Modification of Invention)

Instead of the accelerator pedal 20, a shift pedal (not illustrated) to operate the continuously variable transmission 13 may be provided as the operation pedal. In this case, the continuously variable transmission 13 may be configured as a hydrostatic continuously variable transmission 13 that can continuously vary to a forward side and a reverse side.

In a case where a drive electric motor (not illustrated) and a battery (not illustrated) are provided instead of the engine 12, a shift pedal (not illustrated) configured to perform a speed control on the electric motor may be provided as an operation pedal.

### Second Modification of Invention

The passenger seat 9 may have the same width in the right-left direction as the width of the driver seat 8 so that one passenger sits thereon.

The driver seat 8 and the passenger seat 9 may be connected integrally as a bench seat (not illustrated). In this case, either of right and left portions of the bench seat serves as the driver seat 8, and the other one of the right and left portions of the bench seat serves as the passenger seat 9.

### Third Modification of Invention

In the bottom panel 22, the partition section 25, the pedal arrangement section 23, and the footrest section 24 may be separated from each other to be provided as separate members.

The bottom panel 22 may be provided with no pedal arrangement section 23 and no footrest section 24, and the floor frame 4 may be provided with the pedal arrangement section 23 and the footrest section 24.

The driver seat 8 and the passenger seat 9 adjacent to the driver seat 8 are provided.

The operation pedal (the accelerator pedal 20) which is forward and downward of the driver seat 8 and which is configured to control a traveling speed in response to the operation pedal being stepped on by a driver sitting on the driver seat 8 is provided.

The footrest section 24 which is forward and downward of the passenger seat 9 and which is used for a passenger sitting on the passenger seat 9 to put his or her feet on is provided.

The partition section 25 which is between the operation pedal (the accelerator pedal 20) and the footrest section 24 which separates a region for the operation pedal (the accelerator pedal 20) from the footrest section 24 is provided.

The partition section 25 has a rear portion including the rear inclined surface portion 28 configured such that a further forward portion of the rear inclined surface portion 28 is closer to the footrest section 24 in a plan view.

The rear inclined surface portion 28 is in a shape increasing in width in the right-left direction toward the lower side in a back view.

The partition section 25 includes a lateral surface portion (the left lateral surface portion 27) facing the operation pedal (the accelerator pedal 20) which lateral surface portion includes the lateral inclined surface portion 27b configured such that a further downward portion of the lateral inclined surface portion 27b is closer to the operation pedal (the accelerator pedal 20) in the back view.

The rear inclined surface portion 28 is connected to the lateral inclined surface portion 27b in such a manner that the rear inclined surface portion 28 is a shape increasing in width in the right-left direction toward the lower side to be closer to the operation pedal (the accelerator pedal 20) in the back view.

The partition section 25 includes the upper end portion 29 at a position higher than the operation pedal (the accelerator pedal 20).

### INDUSTRIAL APPLICABILITY

The present invention is applicable to not only a work vehicle including the front wheels 1 and the rear wheels 2 but also a work vehicle including the front wheels 1 and a rear crawler unit (not illustrated) or a work vehicle including right and left crawler units instead of the front wheels 1 and the rear wheels 2.

### DESCRIPTION OF THE REFERENCE NUMERALS

8: driver seat
9: passenger seat
20: accelerator pedal (operation pedal)
24: footrest section
25: partition section
27: left lateral surface portion (lateral surface portion)
27b: lateral inclined surface portion
28: rear inclined surface portion
29: upper end portion

1. A work vehicle, comprising:
a driver seat;
a passenger seat adjacent to the driver seat;
an operation pedal which is forward and downward of the driver seat and which is configured to control a traveling speed of the work vehicle in response to the operation pedal being stepped on by a driver sitting on the driver seat;
a footrest section which is forward and downward of the passenger seat and which is used for a passenger sitting on the passenger seat to put a foot on; and
a partition section which is between the operation pedal and the footrest section and which separates a region for the operation pedal from the footrest section, the partition section having a rear portion comprising a rear inclined surface portion configured such that a further forward portion of the rear inclined surface portion is closer to the footrest section in a plan view.

2. The work vehicle according to claim 1, wherein:
the rear inclined surface portion is in a shape increasing in width in a right-left direction toward a lower side in a back view.

3. The work vehicle according to claim 2, wherein:
the partition section comprises a lateral surface portion facing the operation pedal which lateral surface portion comprises a lateral inclined surface portion configured such that a further downward portion of the lateral inclined surface portion is closer to the operation pedal in the back view, and
the rear inclined surface portion is connected to the lateral inclined surface portion in such a manner as to be in a shape increasing in width in the right-left direction toward the lower side to be directed toward the operation pedal in the back view.

4. The work vehicle according to claim 1, wherein:
the partition section comprises an upper end portion at a position higher than the operation pedal.
